(19) United States
(12) Patent Application Publication
(10) Pub. No.: US 2003/0196176 A1
(43) Pub. Date: Oct. 16, 2003

(54) Method for composing documents

(76) Inventors: Maad H. Abu-Ghazalah, Pacifica, CA (US); Donald R. Boys, Aromas, CA (US)

Correspondence Address: CENTRAL COAST PATENT AGENCY, PO BOX 187, AROMAS, CA, 95004, US

(21) Appl. No.: 10/125,744

(22) Filed: Apr. 16, 2002

(51) Int. Cl. G06F 15/00

(52) U.S. Cl. 715/530

(57) ABSTRACT

A computerized system for preparing a formalized document has a repository of candidate text for use in preparing the document; and an interactive display having selectable indicia to initiate system functions, the display including an editing window. The system is characterized in that the system selects candidate text for the document from the repository and displays the candidate text in the editing window, the user edits the candidate text in the editing window and signals satisfaction, and the system uses the approved text in preparing the formalized document. A system is provided for preparing patent applications.

### FIELD OF THE INVENTION

The present invention is in the field of computerized word and document preparation and processing systems, and pertains more particularly to a system for maximizing efficiency in preparation of documents that have a standard format.

### BACKGROUND OF THE INVENTION

Shortly after the advent of personal computers applications known as word processors were developed, greatly improving ability of people to create and edit documents. Word processors allow persons to key in words and phrases from a keyboard, for example, or even by voice, and the input material is saved in a digital memory and also displayed on a computer monitor screen, formatted as it would appear in a finished document. Tools are provided for reformatting, editing, deleting and the like, and when a document is considered finished, it may be printed, faxed, saved, e-mailed, duplicated, and more. The skilled artisan is quite familiar with word processors, and there are many available examples in the art, such as Microsoft Word™.

Even with full-featured word processors and high-end personal computers, there is still an unmet need. Specifically, the speed of a person to think of what to write when composing a document is typically much greater than the same person's ability to enter the data into the word processor. In the case of repetitive kinds of documents, such as patent applications and legal briefs for example, word processors provide the user with an ability to use pre-formatted templates, and to block text from other documents, and to enter that text into a document being composed (copy and paste), but it is still necessary to find the text to be copied and pasted, and to follow the procedures for selecting, copying and pasting.

Some attempts have been made in the past to provide computer-based systems for producing documents in a manner to alleviate the tasks normally-associated with word processing. One such attempt is the U.S. Pat. No. 6,049,811 issued to Petruzzi et al. on Apr. 11, 2000. The methods used in that system, however, do not go nearly far enough to enable the writer, do not address documents other than a patent application, and follow methods that some writers would find cumbersome. The present invention takes an entirely different approach.

What is needed is an enhanced word processing system providing new tools for language entry and editing, allowing workers to more quickly and efficiently prepare formalized documents of many sorts.

### SUMMARY OF THE INVENTION

In a preferred embodiment of the present application a computerized system for preparing a formalized document is provided, comprising a repository of candidate text for use in preparing the document, and an interactive display having selectable indicia to initiate system functions, the display including an editing window. The system is characterized in that the system selects candidate text for the document from the repository and displays the candidate text in the editing window, the user edits the candidate text in the editing window and signals satisfaction, and the system uses the approved text in preparing the formalized document.

In many cases the formalized document comprises clearly definable separate portions, and the system deals with each separate portion in a pre-programmed order. In one embodiment the system enters approved text for each separate portion in a word processor template as each is approved by the user, such that when the last separate portion is completed, the formalized document is completed as a word processor document, while in another, the system stores the text and prepares the document as a near-final step.

In a preferred embodiment there is a portion for enabling a user to enter and annotate graphical illustrations to be a part of the formalized document prepared. In this case annotation of graphical illustrations may include entry of element numbers and witness lines. Also, there may be a list prepared of element numbers assigned by a user, with each element number associated with an element name and an element function statement also entered by the user. In these cases the system prompts the user for the entry of element numbers, names, and function statements to prepare the list. The list may be stored in the data repository, and the system may use text from the list to provide candidate text to the user in preparing the formalized document. In a preferred embodiment the formalized document is a patent application specification.

In another aspect of the invention a computerized method for preparing a formalized document is provided, comprising the steps of (a) selecting candidate text for the document from a data repository; (b) presenting the candidate text in an editing window of an interactive display; (c) accepting text as finished that is approved by a user through a pre-arranged signal; and (d) using the approved text in preparing the formalized document.

In some preferred embodiments the formalized document comprises clearly definable separate portions, and including separate steps for dealing with each separate portion in a pre-programmed order in preparing the formalized document. In some of these embodiments there are steps for entering approved text for each separate portion in a word processor template as each is approved by the user, such that when the last separate portion is completed, the formalized document is completed as a word processor document. In an alternative embodiment the text is saved, and made into a word processor document as a near-final step.

In some embodiments there are steps enabling a user to enter and annotate graphical illustrations to be a part of the formalized document prepared, which may include entry of element numbers and witness lines. Further, the system may have steps for preparing a list of element numbers assigned by a user, with each element number associated with an element name and an element function statement also entered by the user. The system in these cases prompts the user for the entry of element numbers, names, and function statements to prepare the list. In some cases the list may be stored and text from the list may be used by the system to provide candidate text to the user in preparing the formalized document. The formalized document in some cases is a patent application specification.

In yet another aspect, a computerized system for preparing a patent application specification is provided, comprising a repository of candidate text for use in preparing separate text portions of the patent specification, and an interactive display having selectable indicia to initiate system functions, and an editing window. This system is characterized in that the system constrains preparation of the specification by enabling preparation of each portion in a pre-programmed order, selecting candidate text for each portion from the repository and displaying the candidate text in the editing window, presenting the candidate text to the user in the editing window to be edited, and using approved text in preparing the patent application specification.

In preferred embodiments the patent spec system further comprises a portion for enabling a user to enter and annotate graphical illustrations to be a part of the formalized document prepared, including entry of element numbers and witness lines. In this case the system may prepare a list of element numbers assigned by a user, with each element number associated with an element name and an element function statement also entered by the user, and store the list in the repository. The system may then use the list to provide candidate text to the user in preparing the formalized document.

In some cases the system saves approved text, and prepares a word processor document after all text is entered and approved, while in other cases the document is prepared piece-by-piece as each section of text is approved.

### BRIEF DESCRIPTION OF THE DRAWING FIGURES

FIG. 1 is an architectural drawing of a system supporting a Document Preparation system according to an embodiment of the present invention.

FIG. 2 is an exemplary opening screen in a system according to an embodiment of the present invention.

FIG. 3 is a diagram illustrating a preferred order for preparation of a patent application in an embodiment of the invention.

FIG. 4 is an exemplary interactive screen for preparing a title for a patent application in an embodiment of the invention.

FIG. 5 is an exemplary interactive screen for preparing a “Field of the Invention” portion for a patent application in an embodiment of the invention.

FIG. 6 is an exemplary interactive screen for preparing a “Background of the Invention” portion for a patent application in an embodiment of the invention.

FIG. 7 is an exemplary interactive screen for preparing and annotating a drawing set for a patent application in an embodiment of the invention.

FIG. 8 is an exemplary interactive screen for preparing a “Description of the Preferred Embodiments” portion for a patent application in an embodiment of the invention.

FIG. 9 is an exemplary interactive screen for preparing a claim set portion for a patent application in an embodiment of the invention.

FIG. 10 is an exemplary interactive screen for preparing an Abstract portion for a patent application in an embodiment of the invention.

FIG. 11 is an exemplary interactive screen for preparing a Summary portion for a patent application in an embodiment of the invention.

FIG. 12 is an exemplary interactive screen for preparing a “Brief Description of the Drawings” portion for a patent application in an embodiment of the invention.

### DESCRIPTION OF THE PREFERRED EMBODIMENTS

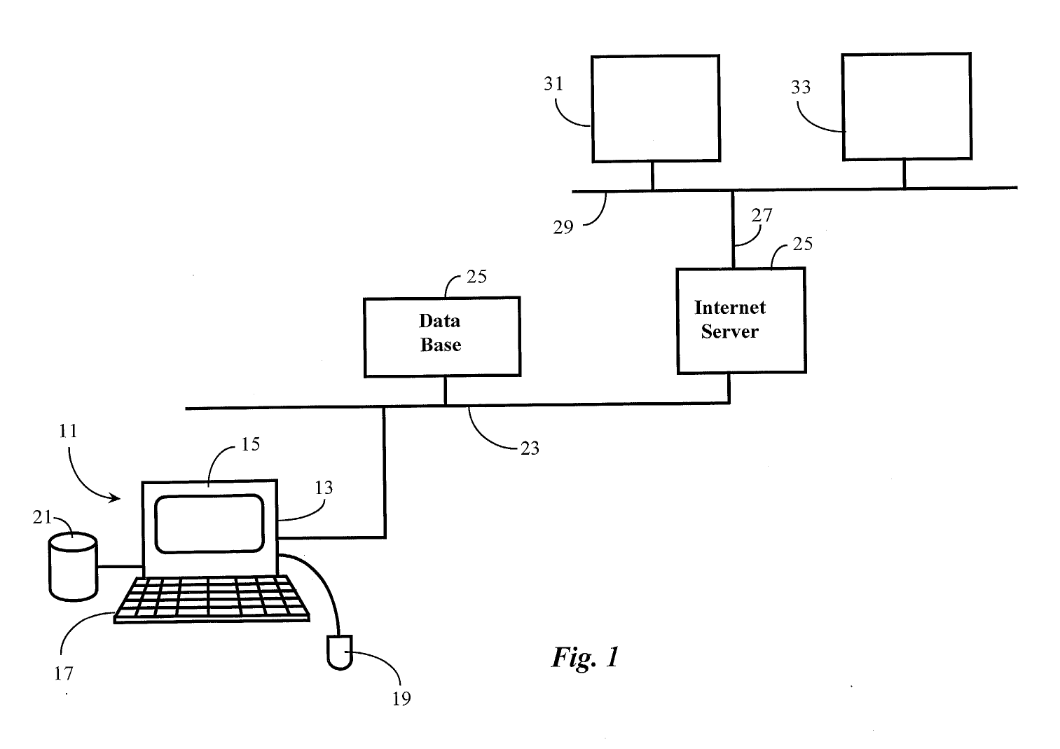

The present invention in various embodiments takes the form of an application program executing on a computer, which may take any one of familiar forms, such as the well-known personal computer (PC); but the invention is not limited to personal computers. Other kinds of computers may be used, as long as there is a processor, sufficient random access and mass storage memory, an input pointer device, an input device enabling a user to input voice or text, and a display monitor. In some cases the system of the invention may execute in distributed parts on more than one computer, communicating on a network, such as a local area network (LAN). FIG. 1 is an architecture schematic of a system supporting a document application according to one embodiment of the present invention. In FIG. 1 a personal computer (PC) system 11 comprises a computer 13, a connected mass storage 21, an input pointer (mouse in this example) 19, a keyboard 17, and a display screen 15. Computer 13 is shown as connected on a local area network 23 to a database 25 and to an Internet server 25. There may be more than one computer system 11 on the LAN, but one is enough to exemplify the invention.

Database 25 may take any of many forms, and there may be more than one database connected on the LAN. Internet server 25 is adapted to provide Internet access for devices communicating on LAN 23, including computer system 11. Internet access is provided through a land-line in this example to an Internet backbone 29, which exemplifies all of the interconnectivity of the well-known Internet network, in this case providing access to two Internet Web servers 31 and 33, exemplary of all of the many such information sources accessible on the Internet.

As previously described, the present invention in various embodiments comprises an application executing on a computer. In the present example the application of the invention executes on computer 13 including an interactive display on display screen 15, which may be manipulated by a user with pointer device 19, as is well-known in the art. In alternative embodiments the application of the invention may execute on a server on LAN 23 with computer 13 operating as a client, and in other ways as well.

In various embodiments the system of the present invention provides software tools maximizing a user's ability to quickly enter and format text to produce a document. The invention is most effective in producing documents that fit a rigid and predefined profile, although this is not a limitation in the definition or use of the invention. There are in the art many such documents, such as legal briefs of various sorts, formal complaints in lawsuits, many kinds of formalized reports, and such things as specifications for patent applications, among others. The example of a patent application is used liberally in this specification.

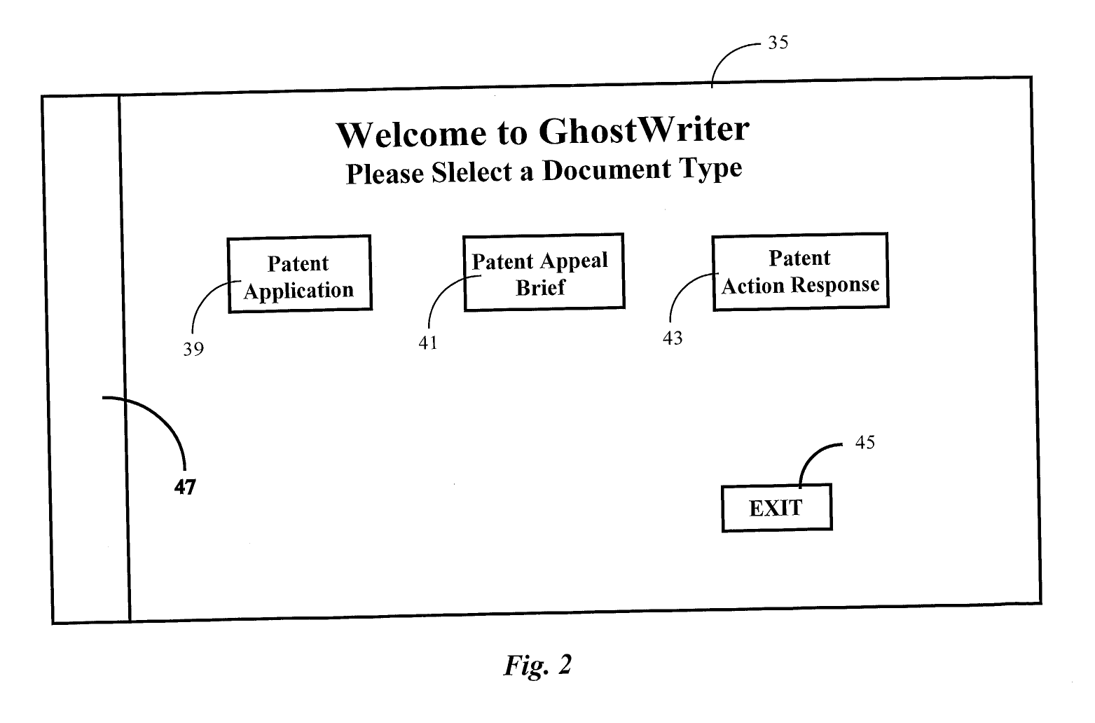

FIG. 2 is an exemplary opening, or top-level, interactive display 35 in an embodiment of the present invention. There is a Welcome message 37, and a directive to please select a document type. Three links 39, 41 and 43 present options to open a patent application, a patent appeal brief, or a patent action response, each of which is a formalized document in patent practice. In preferred embodiments there will be many more options than the three shown, and the selection may comprise many other than patent practice documents, but the three selections shown will serve to illustrate the salient features of the invention. There is also a sidebar 47, which has no tool display in this figure, and an Exit button 45, reactive to initiate closing an open document and terminating execution of the application.

As a result of the selection of link 39, in a preferred embodiment of the invention, a word processor template is selected by the Doc Prep system from database 21 or 25 (FIG. 1). The word processor application can be any one of the well-known, commercially available applications, or a proprietary application associated with the Doc Prep application of the invention, or, in some embodiments may be simply a code set as part of the Doc Prep application. The template is a word processor document fully formatted and pre-configured, having among other things margins set, page numbering set, font size and type set, line numbering configured, and finally, sub-headings and page breaks set according to the user's desires and the United States Patent Office's (USPTO) requirements (assuming the language is English, and the application is to be for the USPTO). Such templates are well-known in the art, a function of most commercially-available word processors, and are used by many workers in preparing documents such as patent applications and many others.

Typically a worker, not having the advantage of a Doc Prep application as in embodiments of the present invention, will open such a template, and then use functions of the word processor to search documents and find text, to cut selected text and paste it in the template, to enter text from the keyboard or by voice-to-text, and to edit text entered until the document is finished.

In some preferred embodiments of the present invention the template selected by the Doc Prep application as a result of the user selecting one of the links in screen 35 is manipulated by the system in response to input by the user in various ones of interactive screens made available in embodiments of the Doc Prep application. In general, candidate text is presented by the system, edited by the user, and then inserted by the system in the template, until the preparation process is complete. In some other preferred embodiments, the system follows all of the same steps, but rather than insert completed and approved text into a template in a piecemeal fashion, stores all of the finished work, and then flows the work product into the template as a final or near-final step. In embodiments described below, the option of inserting into a word processor template piece-by-piece is followed.

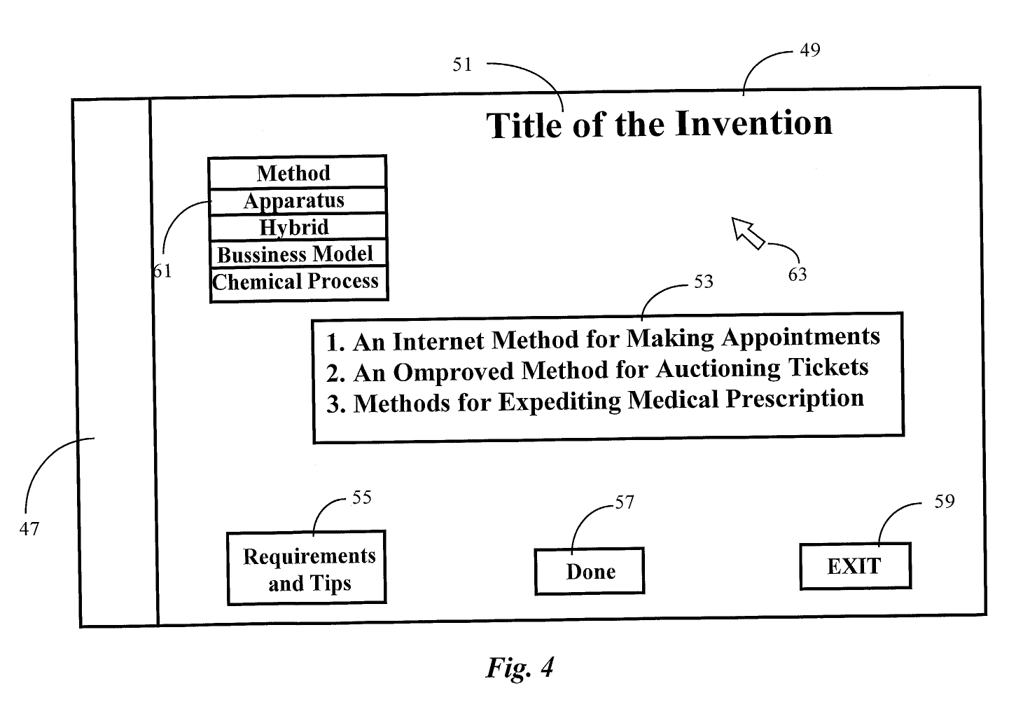

Doc Prep in this example is constrained to follow a particular order in the process of preparing a patent application. This order, in the present example is illustrated in FIG. 4 as Title, to Field of the Invention, to Background of the Invention, to Drawing Set, to Description of the Preferred Embodiments, to the Claim Set, to Abstract, to Summary of the Invention, to Brief description of the Drawing Figures, and finally to a Cross-Reference to Related Documents, which is an optional sub-heading only used if there are related documents to be referenced. The order of this preparation process is somewhat arbitrary, and could be done in different orders, but it will become apparent in further description below that there are good reasons for this particular order as a preference. Also, the skilled artisan will recognize that for other kinds of documents the sub-headings will be different.

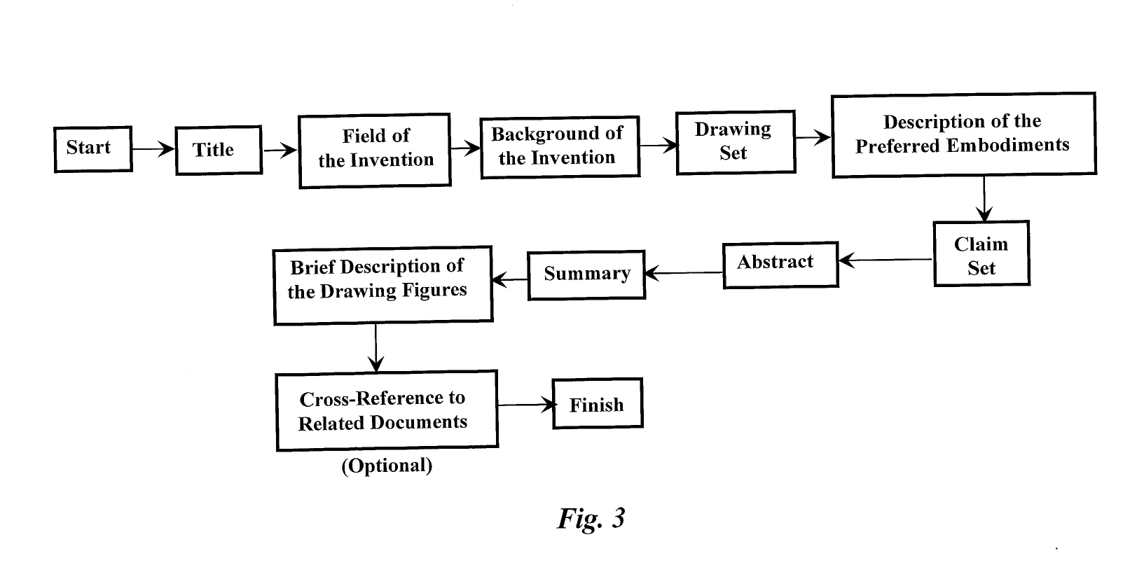

At the same time that the Doc Prep system selects a template for the document selected by the user, the system also presents a new prep screen 49 as shown in FIG. 4, identified by a caption 51 for Title of the Invention. This screen is for providing a title for the invention, which is the first activity in the preferred order shown in FIG. 3. An important object of functions accessible and applicable through screen 49 is to enable the user to provide a title for the invention that is appropriate, and that meets the requirements of the USPTO (in this case), while absolutely minimizing then effort required from the user and the time required.

It is well known that the US Manual of Patent Examining Procedure, known as the MPEP, establishes requirements for a title of an invention in a patent application to be submitted to the USPTO. One function accessible to a user through screen 49 is a succinct summary of the USPTO requirements, together with tips on the purpose of the title. In a preferred embodiment a button 55 allows the user to access such requirements and suggestions, which are displayed in a pop-up screen, which may be scroll-enabled to be able to display a considerable amount of information. In another embodiment these requirements may be listed in a semi-permanent window in screen 49. The window can be closed if the user desires, but otherwise displays as long as screen 49 displays.

Titles follow certain formats, and the formats have relation to the subject mater of the invention. A selection bar 61 provides options for the user to select a type of subject matter. Once a subject matter is selected, the Doc Prep system displays candidate Titles in a prep field 53, which may display multiple lines for displaying more than one title. Candidate titles according to type are pre-stored in either data store 21 or 25, and each candidate title is correct for the USPTO requirements, such as the number of words allowed. When the user selects from bar 61, the Doc Prep system displays the stored candidate titles in field 53.

As an example, assume the user selects “Business Method” from bar 61. The Doc Prep system has a few, in this example three, candidate titles, and displays all three in field 53. Screen 49 shows these titles top to bottom as “An Internet Method for Making Appointments”, “An Improved Method for Auctioning Tickets”, and “Methods for Expediting Medical Prescriptions”.

The theory here is that the form of titles is fairly standard, and with several candidates one should be easily recognizable as very close to a title that will work for the invention that the user wants to compose. With the three candidate titles displayed, the user can select one of the three in any one of several ways. The user may, for example, move a cursor 63 in the screen to the area of one of the three candidates, and click to select. In preferred embodiments the Doc Prep system is enhanced with voice-to-text functionality, and the user has a microphone for voice input. The user may select by a voice input of “one”, “two” or “three”; or “top”, “middle”, or “bottom”.

When the user selects one of the candidates, the other two are removed from the screen. In this example assume the user selects “An Improved Method for Auctioning Tickets”. Now it only remains to amend the candidate title to provide a finished title. The system knows that there are only a limited number of words in the candidate that could have to be changed, and in this case these are only the two words ‘Auctioning Tickets”. Because this is known, the system highlights these two words. The highlight can take any of several forms. The words may be back-lighted as a standard highlight, changed to a bigger and bolder font, may be caused to vibrate in place. The object is to call the user's attention to these two words. The user at this point may speak the correct words to replace the highlighted words in the candidate title. The worker speaks “Composing Documents”. The system substitutes “Composing Documents” for the two highlighted words “Auctioning Tickets”, and the candidate title now reads ““An Improved Method for Composing Documents”. This is the title of the present patent application.

At this point the user either selects the Done button 57, or says “Done”. The Doc Prep system enters the new title in the associated template described above, and the process is well on the way. The description of this process for making a title is fairly long and laborious, but the actual process is short and sweet. As soon as the user selects a document type from bar 61 the system displays the Title prep screen 49. The candidate titles are already displayed. The user says “two” and the selected candidate highlights words to be changed. The user says “Composing Documents”, then “Done”, and the job is finished. It takes at most a couple of seconds to say four words, or to make four inputs with a pointer and two words with the keyboard. There is nothing to think about. Every move is guided. A good title guaranteed.

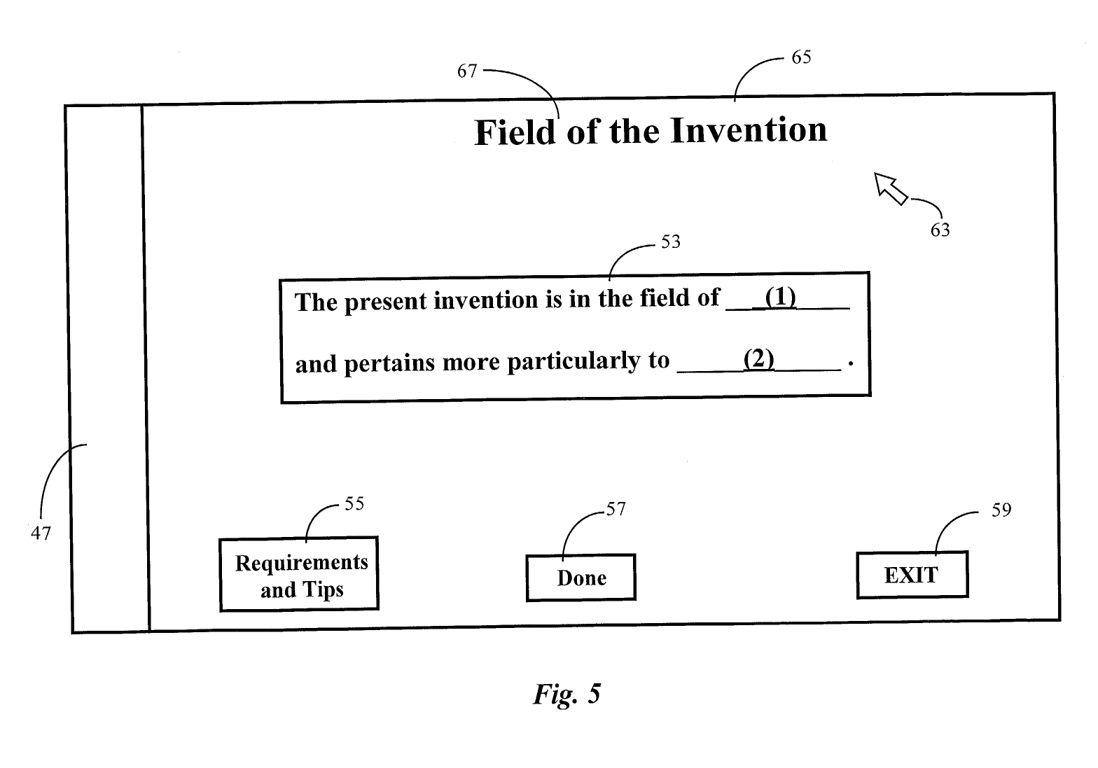

The action of terminating the Title screen also initiates the next screen in the process, which is the Field of the Invention screen 65 shown in FIG. 5. A Title bar 67 identifies the screen and its purpose as composing the Field of the Invention portion of the patent application. It happens that this is also the sub-header in the template associated with the process.

The field of the invention portion of a patent application is typically a single sentence, and can be of the same form in most patent applications. In a preferred embodiment of the invention the Doc Prep system has a single stored sentence with blanks for the key words that make the statement particular to an invention. As soon as screen 65 is displayed the sentence: “The present invention is in the field of (1) and pertains more particularly to (2). The only task for the user is to fill in the two blanks with a word or a phrase for each blank. In the case of the present invention, referring to the actual “field” statement on page 1 of this specification, the phrase that goes in blank (1) is: “word and document preparation and processing systems”, and the phrase that goes in blank (2) is: “a system for maximizing efficiency in preparation of documents that have a standard format”.

It is easily seen that the phrases to complete the “field” statement are relatively long. This is true in this case because the present patent application is written without the benefit of the Doc Prep system of the present invention. Given the aid of the Doc Prep program presenting the boiler-plate sentence shown in FIG. 5, with two blanks, the user would be motivated to provide shorter and more succinct input. For example the phrase “word processors” would suffice for blank (1), and the phrase “enhancements for same”. Either will suffice, and the object is met, because the user is not required to enter any language other than that which is particular to the particular case. Everything else is pre-entered.

Side bar 47 appears in screen 65, and is generic to all such screens. The uses of the side bar are described in some detail elsewhere in this specification. The button 55 for USPTO requirements and purpose and suggestions still appears, as does the button for Done and for Exit. Button 55, if selected in this screen, will provide requirements, purpose and suggestions for the Field of the Invention.

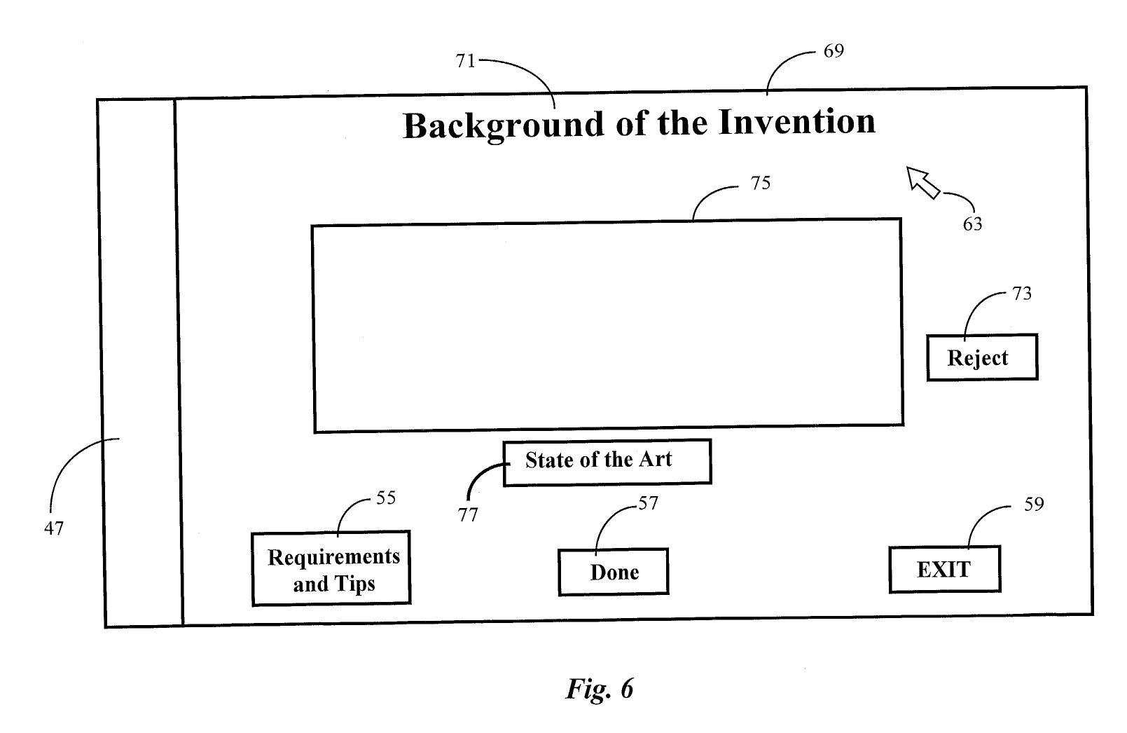

After entering language for the two blanks, the user clicks are speaks Done, and the system immediately enters the finished “Field” sentence in the associated Word template, and switches to the next screen, which is shown in FIG. 6.

Screen 69 in FIG. 6 is dedicated to aiding the user in producing the text for the Background of the Inventions section of the patent application. This section is more extensive than the Field section, and typically needs at least three or more paragraphs. An important object of the invention is to provide as much text as possible automatically, and a good source of text to be used without having to enter new text is Backgrounds that have been written for other patent applications.

In some cases a user will be a non-professional, and may not have an available library of previously-written applications from which to draw candidate material. In other cases the user will be an experienced professional, and will have an extensive library from which to draw. In a preferred embodiment the system needs to accommodate each sort of user.

Rather than providing a complete Background section as a candidate for the application being written, in a preferred embodiment advantage is taken from the observation that a Background section can usually be segregated into distinct portions. These may be named for identification purposes (1) a State of the Art portion, (2) a Problems portion, and (3) a What is Needed portion. So in a preferred embodiment candidate text is made accessible to the program for each of the three portions. A candidate text and editing screen 75 is provided wherein candidate text will appear, and wherein a user may alter the candidate text to provide a portion of the text for a patent application, to be inserted into the template associated with the application.

In a preferred embodiment the system assumes the development will be in the order of the three portions, so the system puts up candidate text for the first portion, unbidden, when the window opens. The candidate text in one embodiment comes from a file of candidate text dedicated to the first portion.

The system has recorded previously the field of the invention. In the example used above, the field of the invention is that for this patent application, that is: word processing systems. The system in one embodiment uses this recorded previous input to at least to try to select a candidate text portion for the patent application under development. One way the system does this in a preferred embodiment is by entering the field statement, or one or more key words from the field statement, as criteria in a search function.

If the system finds a candidate first portion with one or more of the key words, it displays that text in window 75. If not, the system prompts the user to enter a keyword associated with the art of interest. In this case the prompt appears in window 75, and the user may speak or type a word or short phrase, such as “computers”, or “Internet business method”. The system will now use this input for a search, and display candidate text if found. If still no luck, the system will prompt the user if browse is acceptable. If the user enters or speaks “yes”, the system will display a first of the candidate text portions in the display window, to which the user may respond “yes” or “no” or “reject”, or may click on a Reject button 73. This process continues until the user enters yes, then the system goes to edit mode for window 75, displaying candidate text.

In an embodiment particularly useful for professionals, who may be expected to have a considerable database of previously prepared patent applications, the system may use the user's database as a source for candidate text for the first portion of a Background section. In this case there is a further advantage, and that is that the case may have been assigned a matter number that indicates a particular client. Typically a client is associated with a particular technology, and narrowing the search to a client will be quite valuable.

There are a number of ways this process might work in different embodiments. For example, in one embodiment, the user's database may be pre-prepared to accommodate the process, and first portions of Background sections will be flagged, so the search will only process those flagged portions. In another variant, the search function is enhanced to first find subheads of “Background of the Invention” in patent applications in the user's database, which may also be narrowed to only those applications for a particular client, and then to search only the first paragraph of text after the sub-head.

Finding a candidate text having the Field words or phrases, that text is displayed in window 75, just as described above. At this point, when the candidate text is displayed, the user may reject the candidate text, just as described above, by speaking “No” or “Reject”, for example, for voice-enabled systems, and the system will withdraw the candidate and select and display another. The Reject button 73 may also be used.

In yet another embodiment the system is enabled to search remote databases, such as data available in Internet servers, for candidate text. In one embodiment there will be a Web site hosted by a group of cooperating attorneys or legal firms, wherein candidate text is stored for use by all subscribers. Such an on-line database may also be hosted by an enterprise developing and selling systems of the sort described in this patent application. In yet another embodiment a user may register his system with an on-line search service, of which there are several commercially-available, and the system will connect to the Internet (if not already connected), will access the search service, and will enter appropriate criteria for a search, and will finally download candidate text and display same in window 75.

However candidate text is found, when displayed in window 75 and accepted (not rejected in a pre-programmed time window), the user may edit the text in the window. In some cases the window will be a scrolling window to access more text than can be displayed without reducing the font size beyond a comfortable limit.

The state-of-the-art portion of the Background section will typically not be as structured and repeatable as the Field of the Invention section for example. For this reason, in most cases there will be more changes to make than just a word or two. Phrases and perhaps sentences will need to be altered for the candidate text to be suitable for the new invention. Still, having candidate text brought in, as described, will provide a framework for the new text, and many words and phrases will not have to be changed. Further, the existing structure will overcome the common problem of writers in having a block, that is, not being able to think of how to start.

Further to the above, certain enhancements to the usual editing functions of a word processor program may be provided for the user to edit the candidate text, which are more suited to the focused task of altering the candidate text. For example, in one embodiment, a pointer operation of moving the cursor to a position in the text and clicking the left pointer input, such as the left mouse button, for example, will select (block) text from that point rather than requiring the user to wipe across the text or use arrow keys to block the text. This is because in most cases text will need to be replaced rather than added to. In one embodiment the action just mentioned will block text from the entry point to the end of that sentence. The user may then enter or say new text for the blocked portion. In voice-enabled systems the user may also use commands such as “last sentence” and so forth, to block candidate text to be replaced.

Once the user has altered the candidate text for the state-of-the-art portion of the Background section, the user accepts the text in window 75 as described previously for the Field section; that is, by saying “Done”, if the system is voice-enabled, or clicking on the Done button. The system then takes the finished text and enters it in the template under the Background section.

The act of accepting the state-of-the-art portion also causes the system to enter the next portion of the Background, which is the Problems portion. In this formula, after the state-of-the-art is described, the idea is to point out one or more problems in the art that have not been solved, or some unmet need that justifies or motivates the present invention. Again, the system will seek and display candidate text, which the user may finally accept as close to what he or she might write, and then alter and enhance the text until it fits the new invention.

In a preferred embodiment there are two different forms the Problems portion may take. One is to list one or more problems, and the other is to list one or more unmet needs. The system assumes the first option, that of problems, and displays a fixed candidate text that simply begins: “A problem in the art is . . . ”. The user can reject this, and the system will then display candidate text that begins: “there is an unmet need in the art . . . ” The user needs to finish the statement of the problem or the need. In some cases there will be more than one problem or need, and the user may say Duplicate”, or use the word processor editing functions, such as Ctrl-C for copy and Ctrl-V for paste, to duplicate the text and then alter the next part to describe an additional problem of unmet need.

Again, as before, when the Problems portion is suitable for the new invention, the user selects or says Done, and the system adds the text to the already-existing text in the associated template for the Background section. The system automatically indexes to the third portion of the Background, which is the What is Needed portion. This portion is pretty much boiler plate, and the system displays: “What is clearly needed is . . . ” The user simply puts in the correct phrase that completes the sentence in a way to satisfy the new invention. Another Done, and the system adds the last portion to the Background on the associated template, and goes on automatically to the next screen.

Referring again to FIG. 3, the next step in the process of preparing a patent application is preparing a drawing set for the patent application. The drawing set prepared will guide the subsequent preparation of the Description of the Preferred Embodiments section of the specification. This step is considerably different than the other steps in the process, because it involves graphics rather than strictly text.

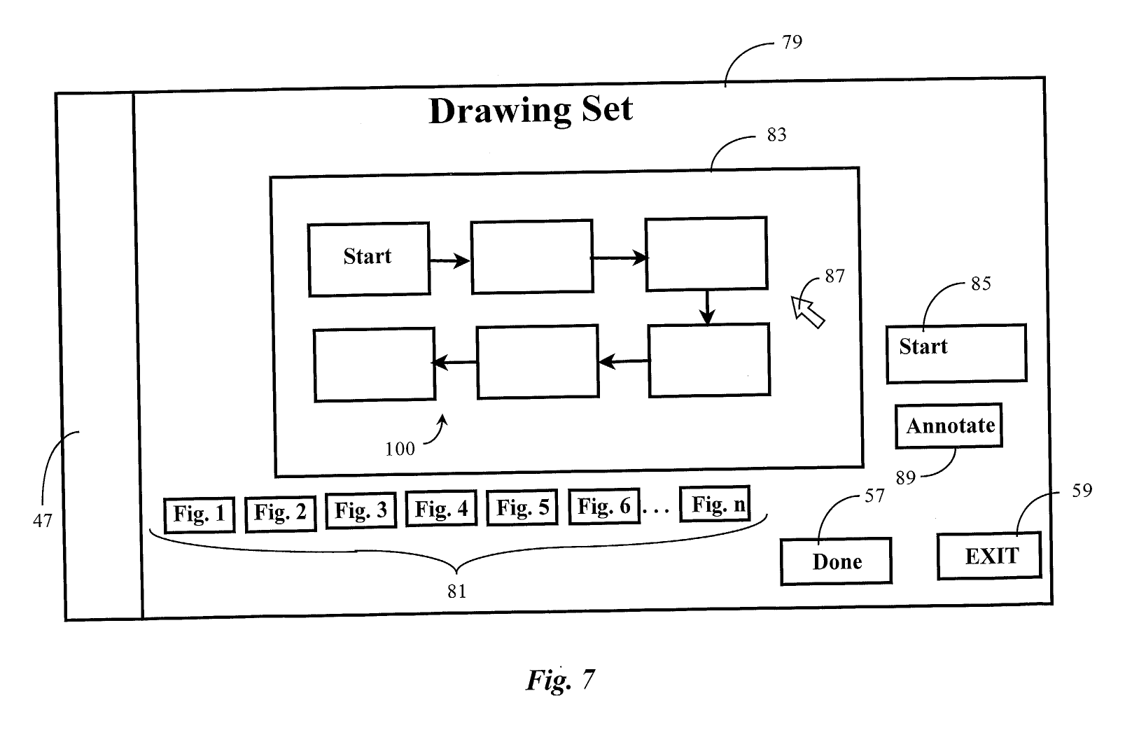

When the user finishes with the Background section, the system indexes automatically to screen 79 shown in FIG. 7 in a preferred embodiment. This screen is functional to aid a user in entering drawings to be figures, to add figure numbers, and to annotate the figures and provide element names and element numbers.

In a preferred embodiment, wherein Microsoft Word™ is the word processor in which the template is prepared, and which the system manipulates to build the new patent application, the figures are also in Word, which is functional for displaying pictures from either object-oriented or bitmap sources. This is done by reserving, at the beginning, one page at the end of the associated Word template for a first figure. In alternative embodiments other drawing programs, either bit-mapped or object oriented, or both, may be used.

Preparing a drawing set for the patent application is at the very heart of the process. For one thing, the drawing set is a legal requirement, According to Title 35 of the United State Code and USPTO rules, drawings are required, and every claim element has to be shown in a drawing. For another, the drawing set guides the description of the invention. A good way to prepare an application is by preparing the drawing set, and then describing the invention by describing the drawings in order. That is the process used by the present invention in a preferred embodiment.

Drawings for the patent application can come from any of a number of original sources. For example, the user may make sketches by hand and scan them into the system. Also, pictures of various sorts, even photographs, may be used. Drawings may also be prepared in one or another of commercially-available bit-mapped or object-oriented drawing programs. What is important is that the user prepare a set of drawings to show the various embodiments of the new invention.

In the case of sketches, pictures or photographs, the user prepares these without captions, figure numbers, or element numbers and witness lines. They are then scanned and saved with pre-arranged file names in a pre-arranged folder, both of which are recognized by the system as the source of figures. Alternatively drawings may be prepared in almost any drawing program, also without figure numbers or captions, element numbers or witness lines, and without annotations. These may be saved directly in the pre-arranged folder.

As figures are saved in the prearranged folder the system recognizes each saved figure in order, and enters a Fig. number on each, starting with FIG. 1. As each figure is numbered an icon appears on screen 79 (FIG. 7) devoted to each figure. The figure icons are shown in FIG. 7 as icons 81 along the bottom of the screen, although they might be made to appear anywhere on the screen.

When the entire drawing set is saved in the pre-arranged folder the user may rearrange the order of the figures by dragging an icon from its position in the order to a new position. The system renumbers all drawings from the new position to the end. Also, at the point that a first drawing enters the system as FIG. 1, that drawing is displayed in an editing window 83. In FIG. 7 a simple flow diagram is shown as an example, and for use in describing further features and functions implemented in screen 79.

When the user is satisfied that all needed figures have been entered, he or she begins a process of annotating the figures with legends, if necessary, element numbers, and witness lines. The protocol in a preferred embodiment is that every figure will have a top-level element, may have lower-order assembly elements, and lowest-level atomic elements. As an example, an apparatus, such as a pair of scissors, will have a top-level assembly number, may have lower-level assemblies, such as each half of the scissors each comprising a handle and a blade, and lowest level, or atomic elements, such as a pivot screw holding the halves together.

The protocol for numbering in this preferred embodiment is that 100 numbers, in which the most significant digit or digits consist of the figure number, and the two least significant digits range in order from 00 to 99. Therefore, for FIG. 1, the top level element is 100. The system, when a FIG. 1 is displayed, inserts element number 100 for the top-level element, and associates a witness line with an arrowhead. The arrowhead is a USPTO protocol, indicating the element is a composite of lower-level elements. The user, manipulating cursor 87 and using the pointer device, may drag the top-level element number along with the witness line in the drawing to a convenient place to indicate the top-level grouping of elements.

Once the system has inserted the top-level element number and witness line, the system enables a text field 85 for the user to enter an element name for the top-level element grouping. In the example of FIG. 7 the name may be, for example, “A flow diagram according to a preferred embodiment of the invention”. The system, as it does in other instances described above, provides candidate text that inserts boilerplate automatically, so the phrase “. . . according to a preferred embodiment of the present invention is already entered. If the user wishes, he or she may delete the automatically-generated text, and edit and enhance the element name as desired, at the end of which the user uses a period or enter keystroke, as before, to signal the end of the entry process, and agreement with the input.

The system takes the entered element name for the top-level element, and enters the element name associated with the element number. This is the beginning of a list, briefly described above, associating element numbers, names, and function statements for future use in describing embodiments of the invention.

Also in the preferred embodiment, after the user enters the element name and signals satisfaction, the system again enables the input field for entry of a “function statement” for the element number and name just entered. The function statement will be associated with the element number and element name as another property of the element. As an example, for the top-level element in FIG. 7, the system provides candidate text: “The purpose of the flow diagram is ______. ” The system knows the name “flow diagram”. The user enters the balance of the text, and signals the end of the entry process as before. Then the system has the top-level element name, the element number, and the function statement associated.

After the user signals satisfaction with the top level element, the system enters a phase of lower-level and atomic element naming and description. In this phase the system allows the user to drag a selection box in the figure, or, alternatively to click on one or more atomic elements, which are well-known select actions in object-oriented drawing programs. In response to the user dragging a selection box, or indicating a group of elements with a series of selections holding the Shift key, for example, the system enters the next available element number, in this case 101, and adds a witness line with an arrowhead, as for the top-level element. If the user clicks at a single location in the drawing, indicating selection of a single, therefore atomic, element, the system enters the next available element number with a witness line without an arrowhead. The user may, as before, move the element numbers and witness lines in the drawing.

Again, the system enables and constrains the process for entry of an element (or assembly) name, and then a function statement. The system continues guiding the user in element numbering and naming until the user is satisfied that all of the elements needed for a full and enabling description have been entered.

Another potential need in any figure, perhaps especially in such as flow diagrams, is annotation. Annotation is handled in any one of several ways. In one embodiment there will be a button on screen 79 for entering an annotation mode. Once the “Annotate” button is selected, the system enters the annotation mode, and text window 85 is then enabled for annotation. Retrieval of candidate text is difficult in this case, because the text can be anything, and is very dependent on the drawing at issue. The user, therefore, enters the text to be added in window 85, and when satisfied, moves the text to the drawing. One may wish, for example, to annotate the flow diagram by inserting the word “Start” in the beginning box of the flow diagram in the drawing. One types “Start” in window 85, and then drags the text into window 83, releasing it at the position needed for annotation.

In some cases it will make sense to provide all or portion of needed annotation in an original drawing to be entered or scanned in. This procedure is encouraged, but it need to be said that annotation entered thusly will be harder to edit later.

Considering the case, as in the example, wherein a flow chart is to be developed, it may be that a default text font and size, and a default word wrap criteria, will provide a text entity that will not be suitable to place in a box, as shown in FIG. 7, for example. For this reason, in a preferred embodiment, functionality is provided that a text entity may be sized by dragging corners and midpoints of a selected entity. That is, once text is entered in window 85, or after dragging to window 83, a text entity will be represented as a text box, as is known in the art, having corner and midpoint handles, such that a user can manipulate the handles to size the box, and the text will be word-wrapped, and changed in font size, to fit. In this way, one may always, within reason, create appropriate text to annotate an entered drawing.

After element numbers, element names, function statements, and annotation is finished for FIG. 1, the user selects the “Done” button, and the system displays the next figure in order, and repeats the process for that figure. This process continues until all of the figures have been processed, at which point a suitable and usable drawing set should be complete.

In some cases it will be necessary at a later time, for any reason, to edit a drawing, to change or add or delete element numbers, to change function statement, to even add a new figure o delete an old one. For this purpose there will be a selection menu element or icon in sidebar 47 to allow a user at any point in the overall process to re-enter the drawing phase. When this function is selected, the system displays an interactive screen similar to that shown in FIG. 7 again, including the icon group 81 indicating the list of figures. One may then select a figure, edit any of the electronically-editable attributes of the figure, and go back to the point in the overall process one has left to re-enter the figure portion. One may also enter a new figure, delete a figure, re-order the figures and so on, and the system of the invention, in a preferred embodiment will automatically respond appropriately. For example, one may scan in a new manually-created drawing. After re-entering the figure mode, the new drawing will shown in group 81 as a new drawing with the next available figure number.

It will usually be the case that one intends a newly-entered drawing to either replace an existing drawing, or to be inserted in the drawing list in some reasonable order, rather than just at the end as a new figure. One may therefore drag the new drawing to a new position in the linear list 81, and the system will automatically renumber the existing drawing set appropriately, including changing the element numbers in the drawing and the element numbers in the associated element name/number/function list. The annotations go with the old drawing as endemic to each drawing, unlike the element numbers.

A new drawing will have to be processed to enter element names, numbers, and annotations, if any. Once all drawings are processed, the system will leave the drawing portion and enter the next developmental phase of the process, as indicated in FIG. 3, which is the description of the preferred embodiments.

After the last figure is finished and “Done” (57) is selected, the system indexes to a first screen for development of the section titled in the template the Description of the Preferred Embodiments. This section is prepared by a linear process of describing each of the drawing figures by describing and referring to each of the elements by name and number, and finally ends with a boilerplate broadening statement. This process, then, requires as many screens as there are figures, plus one. If there are ten figures, for example, the Description of the Preferred Embodiments will be composed in eleven distinct steps, performed in linear order.

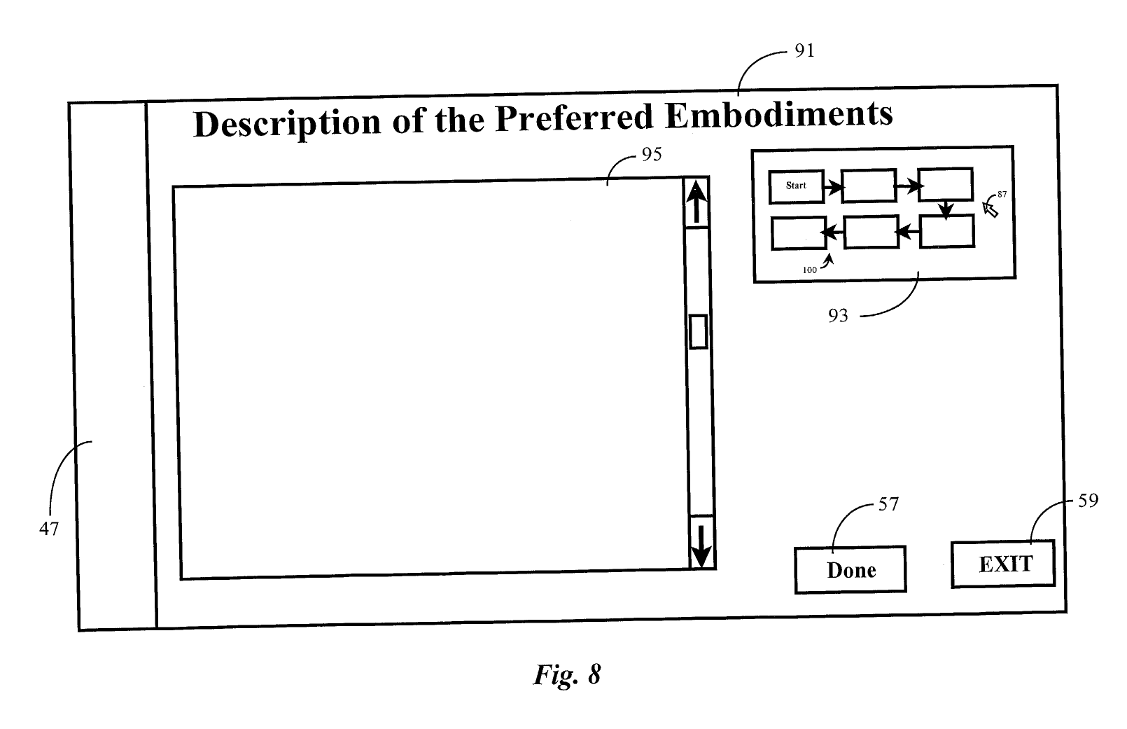

The first screen 91, shown exemplary in FIG. 8, in the Description portion is for describing FIG. 1. The system displays FIG. 1 in a window 93 in one corner of the overall screen for reference by the user in preparing text. The system displays candidate text in the editing window, such as: “FIG. 1 illustrates a xxxxxxxxxx for yyyyyyyyy in a preferred embodiment of the present invention. The system enters the top-level element name and number in the first blank, taken from the element properties file prepared during the element naming and numbering exercise described above in the section for preparing the drawing set, and the “purpose” property for the top-level element in the second blank.

As an example of the process thus far, assume FIG. 1 illustrates a flow diagram describing a process for writing a patent application. In the preparation of the drawing set, the top-level element was then “flow diagram”, the system assigned element number 101, and the “purpose” statement entered was “for describing preparation of a patent application”. The system then, in the first screen for preparing the Description of the Preferred Embodiments, will provide this candidate text: “FIG. 1 illustrates a flow diagram for describing preparation of a patent application.” In some cases there will be some grammatical problem, some of which can be taken care of by the system (two “fors” for example), and some of which may have to be fixed by the user. By far most of the effort is provided by the system, not the user.

The system, in the instant embodiment, as each text piece of the description is completed, enters that piece in order in the associated template, under the sub-head Description of the Preferred Embodiments. In an alternative, as previously described, the pieces may be stored until the process is complete or nearly complete, and the work product may then be flowed into a word processor document.

Following the description already begun, now the system orchestrates the continuing description of FIG. 1. The process is complete for the top-level element, flow diagram 101. Assume now that the next element in ascending order of element numbers, and in descending hierarchy, in this example, is a “subassembly of the flow diagram. Sub-assemblies of a flow diagram may be, for example, alternative flow paths branching from a decision point, or they may be sub-components of an architectural diagram, block diagram or a physical assembly of parts. In any case the system will assume the next descriptive text to be entered will be the next element in ascending order. So the system will display candidate text drawn from the element properties file for that next element.

It may be that the user will desire at this point to describe instead the first step of the flow diagram, which will be an atomic element. The user, then, instead of dealing with the candidate text presented by the system, will click on the element number to be described in the displayed FIG. 1, and the system will then instantly present candidate text for that element, such as “At step 106 in the flow diagram the process of preparing a patent application begins.” Again, the user may have to edit the candidate text to some extent, usually minor, and may at different points in the process need to enter transition statements and the like, to make a smooth and articulate description. But most of the text can be provided by the system using boilerplate descriptive phrasing suitable for the kind of figure that was entered in the drawing prep portion, and drawing on the element numbers and associated names and “function” properties previously entered.

The system has not “forgotten” the next level assembly that it tried to describe when the user intervened to select and describe the first step atomic element. It may be that the user forces the process again and again, to describe sequential steps from the start of the flow diagram up to and including the first decision point (if any). If so, the system tries at every juncture to do the process for the second-level subassembly it tried to initiate before, until the user accepts and edits and completes the text for that one. Then the system assumes the next ordered element, and so forth, and the user may still intervene to finish description for other elements instead.

In the process the system flags every element for which description is completed, and in its own order assumption, skips those elements for which description has been completed due to intervention by the user, until all elements have been described for the figure. Again, as the user signals completion for each piece, that piece is entered in the associated Word template in this embodiment.

In this way the system aids the user in a complete description of FIG. 1, forces that all elements are described, and ensures that the proper element numbers are used, no element number is used more than once, and that all element names are proper and consistent, avoiding common errors typically made in the manual preparation of a patent application.

After the last element of FIG. 1 is properly described, and the user has signaled his approval, the system enters the last piece in the description of FIG. 1, and goes naturally to FIG. 2, and the process is repeated as described for FIG. 1 above.

After the last figure has been fully described, the Description of the Preferred Embodiments should be nearly complete. Again, there will be edits to be made to add such as broadening language and transitional language along the way, but the process is at least semi-automated and controlled so that common errors are eliminated. At this point the system presents candidate text for a boilerplate statement to end the description. That statement may be, for example, “The skilled artisan will recognize that there may be many alterations made in the embodiments of the invention described in enabling detail above, without departing from the spirit and scope of the invention. For example, ______. The user simply enters broadening detail to complete the process.

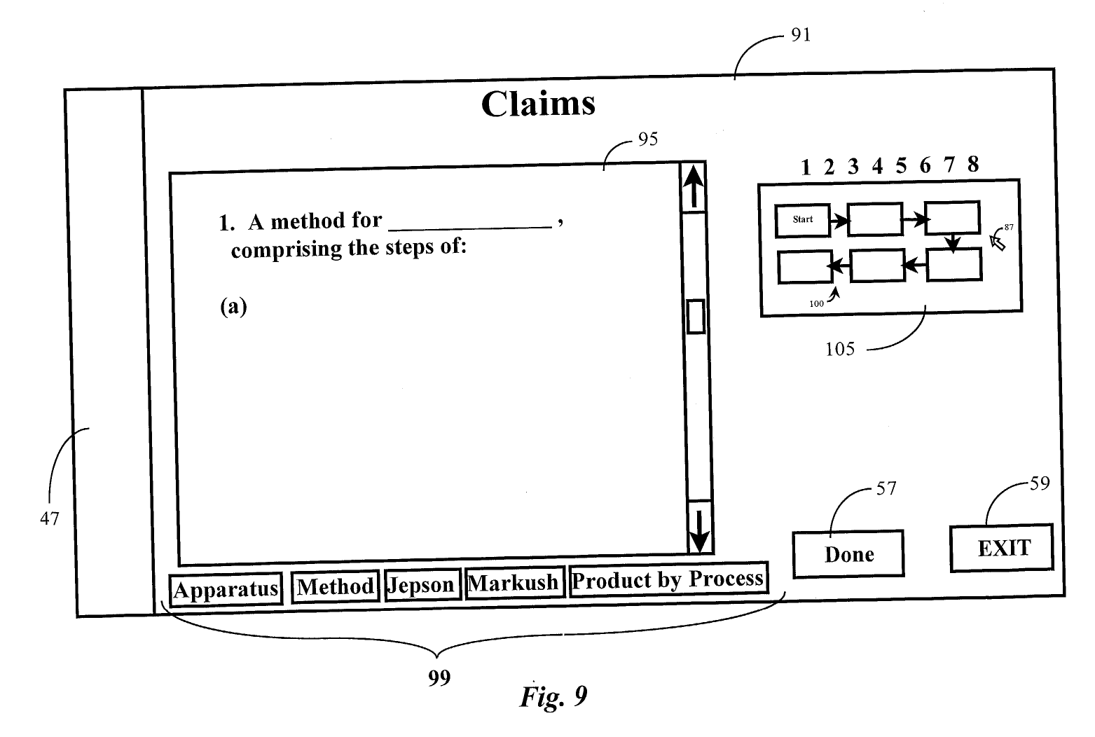

Once the Description of the Preferred Embodiments is finished, the next step in the ordered process is preparation of the claim set (see FIG. 3), and the system moves to a new Prep Window 95 for claims, as shown exemplary in FIG. 9. The claim set is still the beating heart of the patent application, and requires experience and skill for proper completion, and the major effort for the practitioner/user. Writing good claims is an art, and can be done in many different ways. Still, there are standard claim types (format) and language preferred, which may vary for each practitioner. In a preferred embodiment, in this phase, candidate claims are presented by the system for alteration and enhancement by the user. This will be done by providing the user with a menu of claim types: Method, Apparatus, System, Markush, European form, Product by Process, Means for, and perhaps others. These claim types are provided as selectable icons 99 in window 95.

The user picks a claim type, and the system provides a framework, with a claim number, beginning (of course) with 1. The system also enters a property of “independent” for claim 1. As an example, the user may select “Method” for claim 1. The system will provide as candidate:

1. A method for ______, comprising the steps of:

(a)

The system also displays FIG. 1 automatically for the user's reference in preparing claim 1, in a window 105, much as was done for the Description portion, except in this case, numbers up to and including the highest figure number are provided near the figure window for the user to select, which causes the system to display the Fig. number selected. This allows the user to use any one of the figures as motivation in writing a claim.

In the present example, the user fills in the blank, and enters a step (a). At a signal for acceptance of step (a), which may be a pre-arranged keystroke, for example, the system presents (b), and the user may enter the next step, and so forth, until the user is satisfied with the claim.

When the user signals satisfaction, again by a pre-arranged signal, such as a keystroke (Alt for example), the system enters claim 1 in the associated template, or stores the new claim 1 for later input to a template. The system then enables claim 2, which the system assumes will be a dependent claim The system therefore presents:

2. The method of claim 1 wherein ______.

The user fills in the blank with appropriate text and signals satisfaction. The system presents another dependent structure, and the beat goes on, until the user wishes another independent claim. The system continues to display the figure for the user's reference.

The signal, in a preferred embodiment, for a new independent claim is the user selecting a claim type again. It could optionally be a keystroke or a button on the screen instead. When signaled, the system will present a candidate framework for the new type claim selected, mark it as independent, and the process goes on in this fashion until the user is satisfied with the claim set. The basic process is clear. To prepare the claim set, the user must understand the nature and heart of the invention, and this is a necessary function of the user; the system cannot do it.

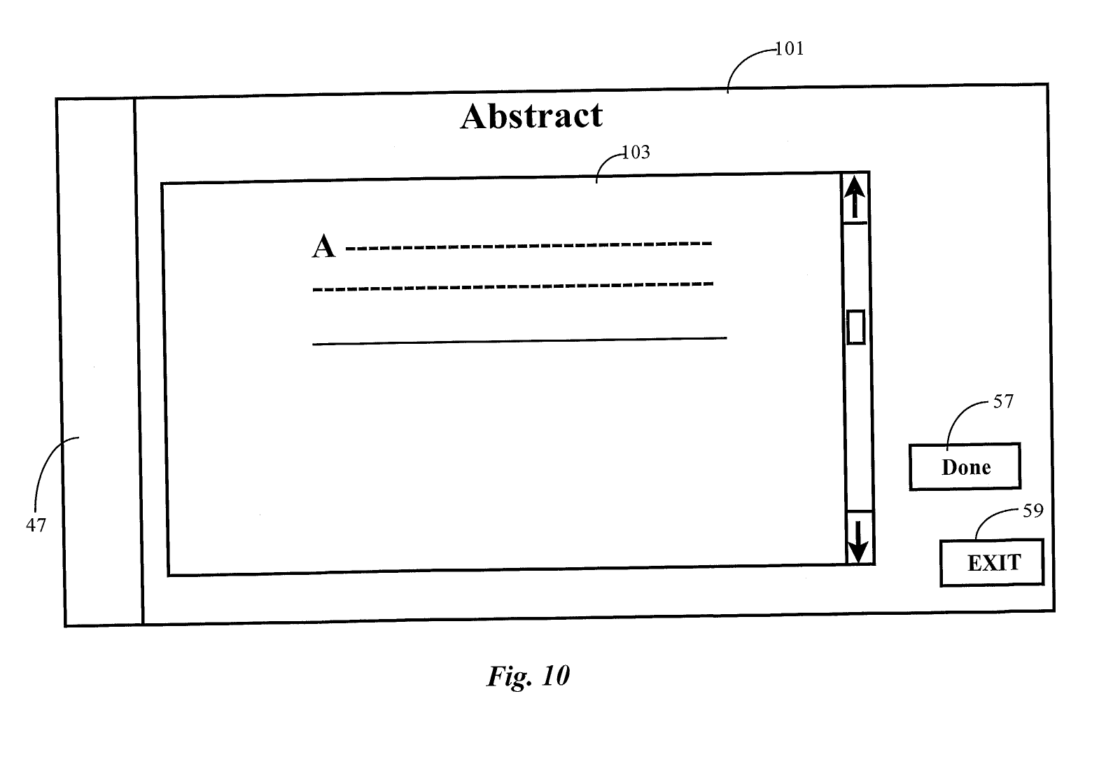

After the claim set is complete, as signaled by the user selecting, in this example, the “Done” button 57, the system moves to a preparation screen 101 for providing an Abstract for the patent application, as shown in FIG. 10.

In nearly all cases a suitable abstract can be derived as a narrative form of the first claim. Assume the first claim is as follows:

1. A system for manipulating a word processor document to prepare a patent application, the system comprising:

a first software module presenting an interactive screen with functions for entering drawings in pages of the word processor document, and for guiding a user in entering element numbers on the drawing and names and purpose statements for the elements; and

second software modules for presenting candidate text in interactive screens for preparing disparate text sections of the patent application, with functions for the user to edit and enhance the text;

characterized in that the system keeps an association of the element numbers, names, and purpose statements provided through the functions of the first module, and uses those in the candidate text presented through the second software modules.

The Abstract will be the narrative form of the claim with a few standardized changes, completely derived from claim 1:

A system for manipulating a word processor document to prepare a patent application, the system has a first software module presenting an interactive screen with functions for entering drawings in pages of the word processor document, and for guiding a user in entering element numbers on the drawing and names and purpose statements for the elements, and second software modules for presenting candidate text in interactive screens for preparing disparate text sections of the patent application, with functions for the user to edit and enhance the text. The system is characterized in the system keeps an association of the element numbers, names, and purpose statements provided through the functions of the first module, and uses those in the candidate text presented through the second software modules.

This process is wholly derivative, easy for the system, and will need minimal cleanup by the user. The system takes claim 1 (already recorded), makes the changes to produce the narrative form, and presents it in editing window 103 for the user to fix if necessary. The user edits, if needed, signals satisfaction, and the system enters the Abstract in the associated word template, or saves the work product to be provided to a word processor document later.

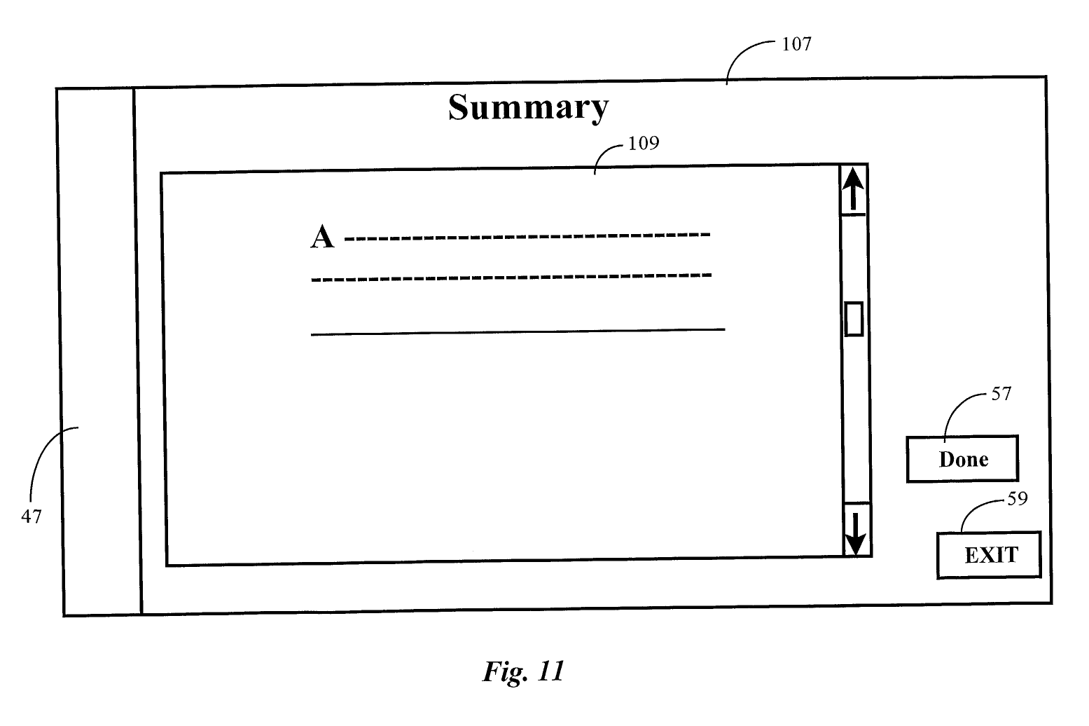

After the user signals satisfaction with the Abstract of the Invention, the system moves to a screen 107 shown in FIG. 11. The Summary is derived in much the same way as the Abstract, but in just a longer process. For the Summary, the entire claim set is produced in the narrative form. For example, beginning with claim 1 from above, and assuming at least one depended claim, for example:

2. The system of claim 1 wherein there are seven second software modules for preparing seven text portions of the patent application.

The first part of the summary will be:

### SUMMARY

In a preferred embodiment of the invention a system for manipulating a word processor document to prepare a patent application is provided, the system comprising a first software module presenting an interactive screen with functions for entering drawings in pages of the word processor document, and for guiding a user in entering element numbers on the drawing and names and purpose statements for the elements, and second software modules for presenting candidate text in interactive screens for preparing disparate text sections of the patent application, with functions for the user to edit and enhance the text. The system is characterized in that the system keeps an association of the element numbers, names, and purpose statements provided through the functions of the first module, and uses those in the candidate text presented through the second software modules.

In one preferred embodiment there are seven second software modules for preparing seven text portions of the patent application.

It may be easily seen by the skilled artisan how the system can derive the entire Summary text from the claim set, provide it all at once, or in sequential portions, for the user to edit and approve, and than enter the entire Summary under the Summary heading in the associated Word template.

In the example shown, the entire Summary is provided, and editing window 109 is a scrolling window. The user simply scrolls through the candidate Summary provided by the system, does whatever cleanup is needed or desired, and signals satisfaction by selecting “Done” button 57.

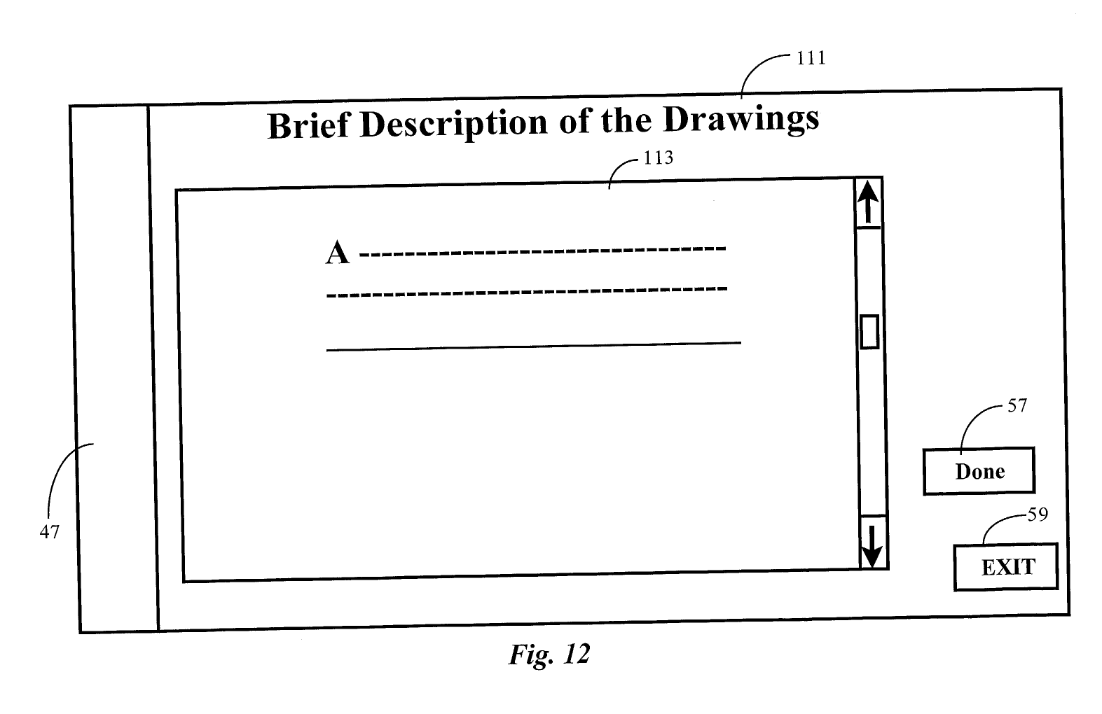

Following the Summary, the system goes to screen 111 shown in FIG. 12, for preparation of a Brief Description of the Drawing Figures. This is the last part of the patent application (in order of preparation), but could have been done at any time after the drawings were prepared, because this portion is wholly derived from the properties of the drawings entered, and the statement for each has already been made in the text of the Description of the Preferred Embodiments. In every beginning for a new figure a phrase was entered such as: “FIG. 1 illustrates a first screen for preparing a Title of the Invention for a patent application in a preferred embodiment of the present invention.”

The system simply lifts these statements from the text of the description of the preferred embodiments. and presents them in order to the user for approval (perhaps after some minimal editing) in preparation of the Description of the Preferred Embodiments.

At this point the patent application is essentially complete. There remains, however, an important step before the user can be confident the work is complete. That is a verification step. It was previously described that the system prepares and maintains a list of all of the elements, including assemblies, subassemblies, and atomic elements, a name for each element, and a function statement for each element. In a preferred embodiment, after the patent application document is complete, as indicated by approval of the Brief Description of the Drawings, or whatever process is the last process in an alternative embodiment, the system, without user prompting, review the document to check as to whether all element numbers and names have been used, and to see if there are any discrepancies or duplications in the element numbers, names, and text entered and approved. If there are any problems, the user is so informed, and the system displays the text at the point of error for correction by the user. After all such problems are repaired the user may then finally approve the document.

In some embodiments, as previously described, the work in progress is saved, and a translation into a word processor document is made at a final, or near final step. In some embodiments the final document is then presented to the user for a final editing pass, and final approval.

In the beginning of the description above it was stated that the example of preparation of a patent application would be used to illustrate the features of the present invention in some preferred embodiments. That has been done. It will be clear to the skilled artisan that there are thousands, if not more, of formalized documents in the world which could be prepared by the present system with suitable adjustments to the portions and procedure. For example, there can be in an alternative embodiment a version to prepare grant requests, following a particular order, and drawing candidate text from a database. Legal briefs of many sorts, such as complaints in law suits, even short stories and the like are amenable to preparation by such a system. In many documents the drawing preparation portion may be altered to provide illustrations to accompany and be embedded in documents. There are nearly endless possibilities, all well within the spirit and scope of the present invention.

Further to the above, there are many sources that may be used for candidate data and text. A local database is just one of several. An enhanced system may have an Internet connection, and may utilize search functions to search the Internet for candidate text, Such a system might well access paten text, for example from the US Patent Office home page, or available legal briefs in other cases that may be reviewed in many places.

User Interface for Database

Much description has been provided relative to embodiments of the invention regarding candidate text extracted by the system from the database, and presented to the user for editing and approval. In at least one embodiment it has also been described that candidate text may come from other sources than a fixed database, such as through search engines on the Internet, for example.

Still, there are some definite advantages to a user, especially if the user is an experienced writer who produces many formalized documents, in having a database with candidate text for the various parts of a document, and the text is familiar to the user. Therefore, in a preferred embodiment an interface is provided for the user to allow the user to access different portions of the database, and to place candidate text therein. The database is structured such that the system knows from where to access candidate text, according to the portion of the process attained by the system. For example, it was described that the system, in a preferred embodiment, first requires the approval of a title for the invention, and firstly presents candidate titles (text) for editing and approval by the user. Several candidate titles may be provided, and the user may select one, or discard all but one. Then the user must edit the final candidate and approve the finished title, which the system then uses for the Title of the Invention.

In the process for the title just reiterated above, the system knows from where in the database to pull up and display the several candidate titles. The candidates are resident in the database in a folder, for example, identified as the folder for candidate titles.

In the instant embodiment, the user is provided an interface into the database through which he or she may access and change the candidate text. For example, a particular patent attorney, using a version of the present invention for preparing a patent application, may have particularly preferred text for titles. He/she may access the database and insert the appropriate candidate text. This can be as simple as accessing files in the folder, opening the individual files one-at-a-time with a conventional word processor application, and deleting, copying and pasting to provide the appropriate candidate text.

In some embodiments the specific database interface does not exist in the system as a part of the code set of the system, but one may still enter the database as is known in the art through, for example, Windows™, and add and delete files, for example, to accomplish the same purpose.

A skilled artisan will recognize that there may be many alterations in the embodiments described herein without departing from the spirit and scope of the invention. There are many ways drop-down menus and icons may be used; further, the system can be done in, for example, HTML, and may be replete with hyperlinks to access data and functionality for the system. Further there are a number of ways the functionality of the present invention may be applied to produce a final result as a word processor document. For example, in the embodiments described above a system of interactive screens are provided. In an alternative embodiment the interactive screens could be imposed on a copy of the word processor template document, and candidate text could appear in the appropriate place in the template, and be editable and approvable. There are many possibilities.

What is claimed is:

1. A computerized system for preparing a formalized document, comprising:
a repository of candidate text for use in preparing the document; and
an interactive display having selectable indicia to initiate system functions, the display including an editing window;
characterized in that the system selects candidate text for the document from the repository and displays the candidate text in the editing window, the user edits the candidate text in the editing window and signals satisfaction, and the system uses the approved text in preparing the formalized document.

2. The system of claim 1 wherein the formalized document comprises clearly definable separate portions, and the system deals with each separate portion in a pre-programmed order.

3. The system of claim 2 wherein the system enters approved text for each separate portion in a word processor template as each is approved by the user, such that when the last separate portion is completed, the formalized document is completed as a word processor document.

4. The system of claim 3 further comprising a portion for enabling a user to enter and annotate graphical illustrations to be a part of the formalized document prepared.

5. The system of claim 4 wherein annotation of graphical illustrations includes entry of element numbers and witness lines.

6. The system of claim 5 comprising functionality for preparing a list of element numbers assigned by a user, with each element number associated with an element name and an element function statement also entered by the user.

7. The system of claim 6 wherein the system prompts the user for the entry of element numbers, names, and function statements to prepare the list.

8. The system of claim 7 wherein the list is stored in the data repository, and the system uses text from the list to provide candidate text to the user in preparing the formalized document.

9. The system of claim 8 wherein the formalized document is a patent application specification.

10. A computerized method for preparing a formalized document, comprising the steps of:
(a) selecting candidate text for the document from a data repository;
(b) presenting the candidate text in an editing window of an interactive display;
(c) accepting text as finished that is approved by a user through a pre-arranged signal; and
(d) using the approved text in preparing the formalized document.

11. The method of claim 10 wherein the formalized document comprises clearly definable separate portions, and including separate steps for dealing with each separate portion in a pre-programmed order in preparing the formalized document.

12. The method of claim 11 comprising steps for entering approved text for each separate portion in a word processor template as each is approved by the user, such that when the last separate portion is completed, the formalized document is completed as a word processor document.

13. The method of claim 12 further comprising steps enabling a user to enter and annotate graphical illustrations to be a part of the formalized document prepared.

14. The method of claim 13 wherein annotation of graphical illustrations includes entry of element numbers and witness lines.

15. The method of claim 14 comprising steps for preparing a list of element numbers assigned by a user, with each element number associated with an element name and an element function statement also entered by the user.

16. The method of claim 15 comprising steps for prompting the user for the entry of element numbers, names, and function statements to prepare the list.

17. The method of claim 16 comprising a step for storing the list in the data repository, and using text from the list to provide candidate text to the user in preparing the formalized document.

18. The method of claim 17 wherein the formalized document is a patent application specification.

19. A computerized system for preparing a patent application specification, comprising:
a repository of candidate text for use in preparing separate text portions of the patent specification; and
an interactive display having selectable indicia to initiate system functions, and an editing window;
characterized in that the system constrains preparation of the specification by enabling preparation of each portion in a pre-programmed order, selecting candidate text for each portion from the repository and displaying the candidate text in the editing window, presenting the candidate text to the user in the editing window to be edited, and using approved text in preparing the patent application specification.

20. The system of claim 19 further comprising a portion for enabling a user to enter and annotate graphical illustrations to be a part of the formalized document prepared, including entry of element numbers and witness lines.

21. The system of claim 20 wherein the system, in the graphical portion, prepares a list of element numbers assigned by a user, with each element number associated with an element name and an element function statement also entered by the user, and stores the list in the repository.

22. The system of claim 21 wherein the list stored in the data repository is used by the system to provide candidate text to the user in preparing the formalized document.

23. The system of claim 19 wherein the system saves approved text, and prepares a word processor document after all text is entered and approved.

24. The system of claim 19 wherein the system enters each approved portion of text, as it is approved, into a word processor template, such that, after the last portion is approved, the patent application is complete as a word processor document.
